(19) United States
(12) Patent Application Publication
(10) Pub. No.: US 2007/0252908 A1
(43) Pub. Date: Nov. 1, 2007

(54) Method of Creating Colour Image, Imaging Device and Imaging Module

(76) Inventor: Timo Kolehmainen, Oulu (FI)

Correspondence Address: Hollingsworth & Funk, 8009 34th Avenue South, Suite 125, Minneapolis, MN, 55425, US

(21) Appl. No.: 11/661,532

(22) PCT Filed: Sep. 9, 2004
(86) PCT No.: PCT/FI04/00522

§ 371 Date: Feb. 27, 2007

(51) Int. Cl. H04N 3/15

(52) U.S. Cl. 348/265; 382/302

(57) ABSTRACT

An imaging device comprising at least three image capturing apparatuses is provided. Each apparatus includes a lens system and a sensor and is configured to produce an image. The device further comprises a processor configured to combine at least a portion of the images with each other to produce a colour image. Each lens system comprises a phase mask which modifies the phase of incoming rays of light such that distribution of rays after the lens system is insensitive to the location of the sensor.

### FIELD

The invention relates to creating a colour image in an imaging device comprising at least three image capturing apparatuses.

### BACKGROUND

The popularity of photography is continuously increasing. This applies especially to digital photography as the supply of inexpensive digital cameras has improved. Also the integrated cameras in mobile phones have contributed to the increase in the popularity of photography.

There is a growing demand for small cameras. The small size of cameras presents a challenge for camera manufacturers as reducing the size of the cameras should not preferably reduce the quality of the images the camera produces.

A possibility to reduce the size of cameras is to use lenslet technology. This solution is especially useful in digital cameras. In lenslet technology, a camera is realized with at least three image capturing apparatuses, each apparatus including a separate lens system. The apparatuses produce an image using a sensor. The distance between the lenses and the sensor in lenslet cameras is considerably shorter compared to conventional cameras. Thus, the camera may be designed to be small. One known problem associated with lenslet cameras is that the lenslet system requires high precision in the manufacturing phase. A lenslet camera requires accurate optical elements and precise alignment between the elements. So far, it has been very difficult to implement a focusing mechanism in lenslet cameras.

The quality of images is naturally important for every photographer. In many situations it is difficult to evaluate correct parameters to be used in photographing. In many cases, small size cameras determine many parameters automatically as the user interface of the camera must be kept simple. For example, many cameras are equipped with an auto-focus system, where the user does not need to take care of the focusing. The camera may measure the distance between the object and the camera and focus automatically on the basis of the measurement, or the focus of the camera may be fixed to a predetermined distance (in practice to infinity). The latter alternative is popular especially in low-cost cameras. However, this alternative requires precision in the manufacturing phase.

Wavefront coding technology (WFC) has been proposed to increase depth of field. WFC is described in WO 09052331, for example. When a camera is focused to an object at a given distance, the depth of field is the area in front and behind the object which appears to be sharp. With WFC, the depth of field can be increased typically by a factor of ten. However, WFC has so far been utilized mainly in monochrome imaging systems, since it suffers from non-optimal signal sampling in colour cameras utilizing the common Bayer matrix.

### BRIEF DESCRIPTION OF THE INVENTION

An object of the invention is to provide an improved solution for creating colour images. Another object of the invention is to facilitate manufacturing of cameras by reducing precision requirements.

According to an aspect of the invention, there is provided an imaging device comprising at least three image capturing apparatuses, each apparatus including a lens system and a sensor and being configured to produce an image, the device further comprising a processor configured to combine at least a portion of the images with each other to produce a colour image. Each lens system comprises a phase mask which modifies the phase of incoming light rays such that distribution of rays after the lens system is insensitive to the location of the sensor.

According to another aspect of the invention, there is provided a method of creating a colour image in an imaging device comprising at least three image capturing apparatuses, each apparatus including a lens system and a sensor and being arranged to produce an image, where the colour image is produced by combining at least a portion of the images with each other. The method comprises processing incoming rays of light in each lens system with a phase mask which modifies the phase of the incoming rays of light of such that the distribution of rays after the lens system is insensitive to the location of the sensor; processing the image obtained by each apparatus in a processor by removing the effect of the phase mask from the image; and combining the processed images produced with each apparatus with each other, thus obtaining a colour image.

According to another aspect of the invention, there is provided an imaging device module comprising at least three image capturing apparatuses, each apparatus including a lens system and a sensor and being configured to produce an image. Each lens system comprises a phase mask which modifies the phase of incoming rays of light such that distribution of rays after the lens system is insensitive to the location of the sensor.

The invention provides several advantages. In an embodiment, the invention enables lenslet technology to be used in colour cameras as the precision requirements related to manufacturing may be avoided. WFC makes it unnecessary to focus the lenslet camera due to the extended depth of field inherent to the WFC.

The WFC can be efficiently utilised in a colour lenslet camera as the problems related to a Bayer matrix solution may be avoided. The use of WFC in a lenslet camera solves the problem of irregular and sparse sampling for colour components. As each RGB colour component is sampled separately, the sampling is regular and non-sparse (each pixel is sampling the same spectrum component).

With a phase mask, the depth of focus range can be made for example 10 to 20 times larger compared to a conventional system. The invention makes a lenslet camera insensitive to focusing errors. In this way, the camera does not require accurate and expensive optical elements nor a focusing mechanism built into the camera system. It is possible to use standard techniques, such as standard injection moulding, for manufacturing the lenses used in lenslet cameras. As focusing is not required in the production, the construction is simple, robust, fast to manufacture and inexpensive.

### LIST OF DRAWINGS

In the following, the invention will be described in greater detail with reference to the embodiments and the accompanying drawings, in which

FIG. 1 illustrates an example of an imaging device of an embodiment;

FIGS. 2A and 2B illustrate an example of an image sensing arrangement,

FIG. 2C illustrates an example of colour image combining,

FIGS. 3A and 3B illustrate phase masking and inverse filtering of an image;

FIGS. 4A and 4B illustrate a ray-based example of the operation of a phase mask.

FIG. 5 illustrates the operation of a signal processor.

### DESCRIPTION OF EMBODIMENTS

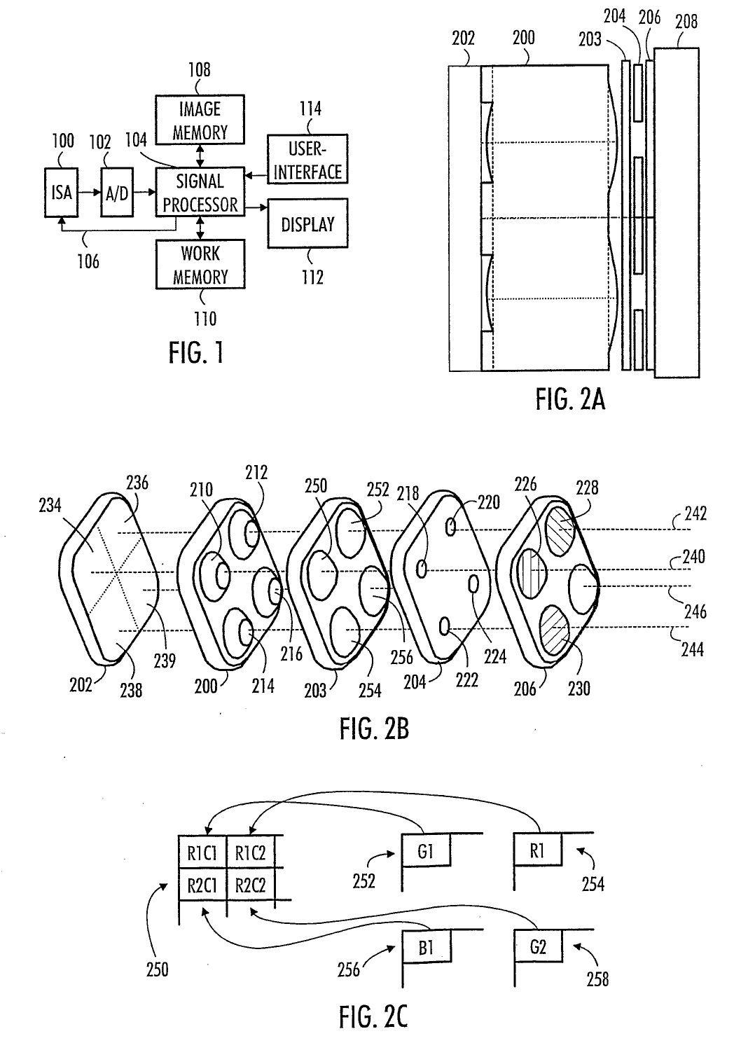

FIG. 1 illustrates a generalised digital image device which may be utilized in some embodiments of the invention. It should be noted that embodiments of the invention may also be utilised in digital cameras different from the apparatus of FIG. 1, which is just an example of a possible structure.

The apparatus of FIG. 1 comprises an image sensing arrangement 100. The image sensing arrangement comprises a lens assembly and an image sensor. The structure of the arrangement 100 will be discussed in more detail below. The image sensing arrangement captures an image and converts the captured image into an electrical form. Electric signal produced by the apparatus 100 is led to an A/D converter 102 which converts the analogue signal into a digital form. From the converter the digitised signal is taken to a signal processor 104. The image data is processed in the signal processor to create an image file. An output signal of the image sensing arrangement 100 contains raw image data which needs post-processing, such as white balancing and colour processing. The signal processor is also responsible for giving exposure control commands 106 to the image sensing arrangement 100.

The apparatus may further comprise an image memory 108 where the signal processor may store finished images, a work memory 110 for data and program storage, a display 112 and a user interface 114, which typically comprises a keyboard or corresponding means for the user to give input to the apparatus.

FIG. 2A illustrates an example of an image sensing arrangement 100. In this example, the image sensing arrangement comprises a lens assembly 200 which comprises a lenslet array with four lenses. The arrangement further comprises an image sensor 202, a phase mask arrangement 203, an aperture plate 204, a colour filter arrangement 206 and an infra-red filter 208.

FIG. 2B illustrates the structure of the image sensing arrangement from another point of view. In this example, the lens assembly 200 comprises four separate lenses 210 to 216 in a lenslet array. Correspondingly, the aperture plate 204 comprises a fixed aperture 218 to 224 for each lens. The aperture plate controls the amount of light that is passed to the lens. It should be noted that the structure of the aperture plate is irrelevant to the embodiments, i.e. the aperture value of each lens does not have to be the same. The number of lenses is not limited to four, either.

The phase mask arrangement 203 of the image sensing arrangement comprises a phase mask 250 to 256 for each lens. The phase mask modifies the phase of incoming light rays such that the distribution of rays after the lens is insensitive to the location of the sensor. The phase mask may also be realized as a film coating on the surface of the lens. The phase mask will be explained later in more below.

In this example, the colour filter arrangement 206 of the image sensing arrangement comprises three colour filters, i.e. red 226, green 228 and blue 230 in front of lenses 210 to 214, respectively. In this example, the sensor array 202 is divided into four sections 234 to 239. Thus, in this example the image sensing arrangement comprises four image capturing apparatuses 240 to 246. Thus, the image capturing apparatus 240 comprises a colour filter 226, an aperture 218, a phase mask 250, a lens 210 and a section 234 of the sensor array. Respectively, the image capturing apparatus 242 comprises a colour filter 228, an aperture 220, a phase mask 252, a lens 212 and a section 236 of the sensor array and the image capturing apparatus 244 comprises a colour filter 230, an aperture 222, a phase mask 254, a lens 214 and a section 238 of the sensor array. The fourth image capturing apparatus 246 comprises an aperture 224, a phase mask 256, a lens 216 and a section 239 of the sensor array. Thus, in this example the fourth apparatus 246 comprises no colour filter.

The image sensing arrangement of FIGS. 2A and 2B is thus able to form four separate images on the image sensor 202. The image sensor 202 is typically, but not necessarily, a single solid-state sensor, such as a CCD (Charged Coupled Device) or a CMOS (Complementary Metal-oxide Semiconductor) sensor known to one skilled in the art. In an embodiment, the image sensor 202 may be divided between lenses, as described above. The image sensor 202 may also comprise four different sensors, one for each lens. The image sensor 202 converts light into an electric current. This electric analogue signal is converted in the image capturing apparatus into a digital form by the A/D converter 102, as illustrated in FIG. 1. The sensor 202 comprises a given number of pixels. The number of pixels in the sensor determines the resolution of the sensor. Each pixel produces an electric signal in response to light. The number of pixels in the sensor of an imaging apparatus is a design parameter. Typically in low-cost imaging apparatuses the number of pixels may be 640×480 along the long and short sides of the sensor. A sensor of this resolution is often called a VGA sensor. In general, the larger the number of pixels in a sensor, the more detailed an image produced by the sensor.

The image sensor 202 is thus sensitive to light and produces an electric signal when exposed to light. However, the sensor is not able to differentiate different colours from each other. Thus, the sensor as such produces only black and white images. A number of solutions is proposed to enable a digital imaging apparatus to produce colour images. It is well known to one skilled in the art that a full colour image can be produced using only three basic colours in the image capturing phase. One generally used combination of three suitable colours is red, green and blue (RGB). Another widely used combination is cyan, magenta and yellow (CMY). Other combinations are also possible. Although all colours can be synthesised using three colours, other solutions are also available, such as RGBE, where emerald is used as the fourth colour.

One solution used in a single-lens digital image capturing apparatus is to provide a colour filter array in front of an image sensor, the filter consisting of a three-colour pattern of RGB or CMY colours. Such a solution is often called a Bayer matrix. When using an RGB Bayer matrix filter, each pixel is typically covered by a filter of a single colour in such a way that in a horizontal direction, every other pixel is covered with a green filter and every other pixel is covered by a red filter on every other line and by a blue filter on every other line. A single colour filter passes through to the sensor pixel under the filter light whose wavelength corresponds to the wavelength of the single colour. A signal processor interpolates the image signal received from the sensor in such a way that all pixels receive a colour value for all three colours. Thus a colour image can be produced.

In the multiple lens embodiment of FIG. 2A, a different approach is used in producing a colour image. The image sensing arrangement comprises a colour filter arrangement 206 in front of the lens assembly 200. In practice the filter arrangement may also be located in a different part of the arrangement, for example between the lenses and the sensor. In an embodiment, the colour filter arrangement 206 comprises three filters, one of each of the three RGB colours, each filter being in front of a lens. Alternatively, CMY colours or other colour spaces may also be used. In the example of FIG. 2B, the lens 210 is associated with a red filter, the lens 212 with a green filter and the lens 214 with a blue filter. Thus, one lens 216 has no colour filter. As illustrated in FIG. 2A, in an embodiment the lens assembly may comprise an infra-red filter 208 associated with the lenses. The infra-red filter does not necessarily cover all lenses since it may also be situated elsewhere, for example between the lenses and the sensor.

Each lens of the lens assembly 200 thus produces a separate image to the sensor 202. The sensor is divided between the lenses in such a way that the images produced by the lenses do not overlap. The area of the sensor divided to the lenses may be equal, or the areas may be of different sizes, depending on the embodiment. In this example, let us assume that the sensor 202 is a VGA imaging sensor and that the sections 234 to 239 allocated for each lens are of Quarter VGA (QVGA) resolution (320×240).

As described above, the electric signal produced by the sensor 202 is digitised and taken to the signal processor 104. The signal processor processes the signals from the sensor such that three separate subimages from the signals of lenses 210 to 214 are produced, one filtered with a single colour. The signal processor further processes the subimages and combines a VGA resolution image from the subimages. FIG. 2C illustrates one possible embodiment to combine the final image from the subimages. This example assumes that each lens of the lenslet comprises a colour filter such that there are two green filters, one blue and one red. FIG. 2C shows the top left corner of a combined image 250, and four subimages, a green one 252, a red one 254, a blue one 256 and a green one 258. Each of the subimages thus comprises a 320×240 pixel array. The top left pixels of the subimages correspond to each other and differ only in that the colour filter used in producing the pixel information is different. The subimages are first registered. Registering means that any two image points are identified as corresponding to the same physical point. The top left pixel R1C1 of the combined image is taken from the green1 image 252, The pixel R1C2 is taken from the red image 254, the pixel R2C1 is taken from the blue image 256 and the pixel R2C2 is taken from the green2 image 258. This process is repeated for all pixels in the combined image 250. After this the combined image pixels are fused together so that each pixel has all three RGB colours. The final image corresponds in total resolution with the image produced with a single lens system with a VGA sensor array and a corresponding Bayer colour matrix.

In an embodiment, when composing the final image, the signal processor 104 may take into account a parallax error arising from the distances of the lenses 210 to 214 from each other.

The electric signal produced by the sensor 202 is digitised and taken to the signal processor 104. The signal processor processes the signals from the sensor in such a way that three separate subimages from the signals of the lenses 210 to 214 are produced, one being filtered with a single colour. The signal processor further processes the subimages and combines a VGA resolution image from the subimages. Each of the subimages thus comprises a 320×240 pixel array. The top left pixels of the subimages correspond to each other and differ only in that the colour filter used in producing the pixel information is different. Due to the parallax error, the same pixels of the subimages do not necessarily correspond to each other. The parallax error is compensated for by an algorithm. The final image formation may be described as comprising many steps: first, the three subimages are registered (also called matching). Registering means that any two image points are identified as corresponding to the same physical point). Then, the subimages are interpolated and the interpolated subimages are fused to an RGB-colour image. Interpolation and fusion may also be in another order. The final image corresponds in total resolution to the image produced with a single lens system with a VGA sensor array and a corresponding Bayer colour matrix.

The subimages produced by the three image capturing apparatuses 240 to 244 are used to produce a colour image. The fourth image capturing apparatus 246 may have properties different from those of the other apparatuses. The aperture plate 204 may comprise an aperture 224 of a size for the fourth image capturing apparatus 246 different from those of the three other image capturing apparatuses. The signal processor 104 may be configured to combine at least a portion of the subimage produced with the fourth image capturing apparatus with the subimages produced with the three image capturing apparatuses 240 to 244 to produce a colour image with an enhanced image quality. The signal processor 104 may be configured to analyse the images produced with the image capturing apparatus and to determine which portions of the images to combine. The fourth image capturing apparatus may also be utilised in many other ways not related to the present invention and not explained here.

Let us study the phase mask arrangement. The operation of a lens system is often described using an optical transfer function (OTF). The optical transfer function describes how the lens system affects the light rays passing through the lens system. The optical transfer function gives attenuation T of the light rays and phase shift θ of the light rays in the lens system as a function of spatial frequencies ω:
OTF(ω)=T(ω)·e^{iθ(ω)}

The attenuation T may be called a modulation transfer function (MTF) and the phase shift θ may be called a phase transfer function (PTF). The phase mask modifies the optical transfer function of the lens system in such a way that the transfer function is insensitive to the location of the sensor.

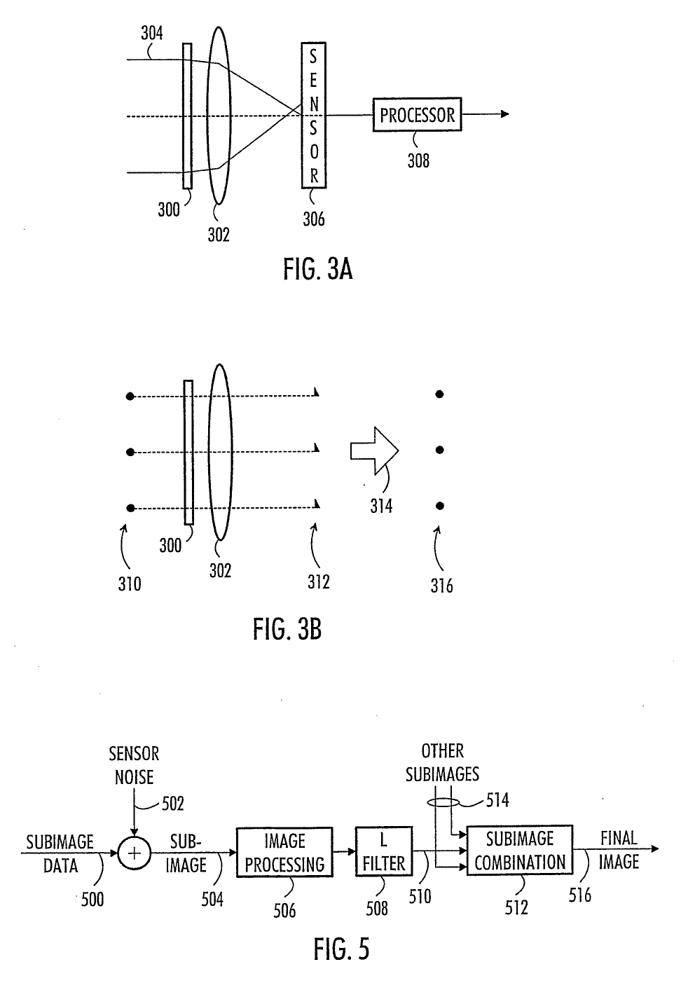

FIG. 3A illustrates the operation of the phase mask arrangement 203. The figure shows a phase mask 300 and a lens 302. In this example, the phase mask is in front of the lens. The mask may also be implemented as a film coating on either side of the lens surface. In practice, the preferred location of the phase mask is near an aperture stop of the lens system. In this example, incoming light rays 304 first arrive to the phase mask. The phase mask modifies the phase of the wavefront of the incoming light. The wavefront goes through the lens 302 and the refracted light proceeds to an image sensor 306. The sensor detects the light and converts it to an electric signal. The signal is taken to a processor 308. As the optical transfer function is modified by the phase mask, the modifications must be compensated for so that a sharp image may be acquired. The processor performs image reconstruction, such as filtering, on the signal. The reconstruction may comprise filtering the signal with an inverse function of the approximate optical transfer function of the lens system.

In FIG. 3B, three spots 310 are photographed by the lens system comprising a lens 302 and a phase mask 300. The sensor detects three spots 312. The spots become larger and unsymmetrical due to the phase mask. However, the spots are always similar in every field point of the image almost regardless of the distance between an object and the lens system. As the distortion of the spots depends on the properties of the phase mask it is known, and by processing 314 a sensor output with an inverse filter the distortion may be eliminated. As a result, smaller spots 316 are then obtained.

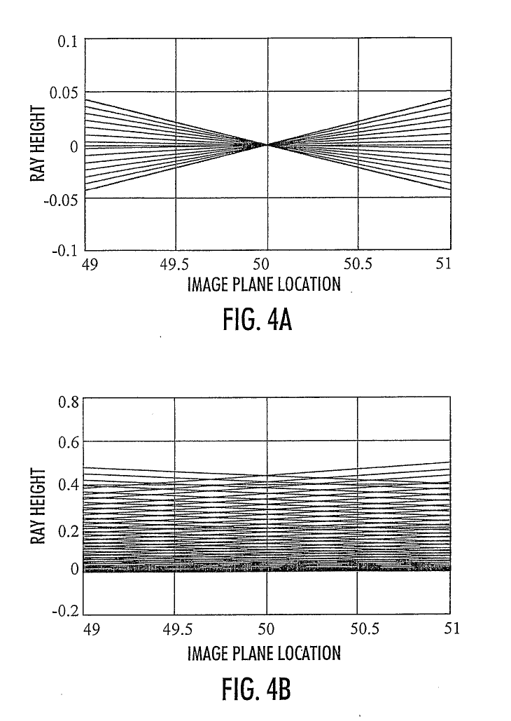

FIGS. 4A and 4B illustrate a ray-based example of the operation of the phase mask. In FIG. 4A, a single ideal classical lens with a focal length of 50 is assumed to be in the zero position of the x-axis. The lens focuses parallel light rays onto an image plane at x=50. Thus, a sharp image can be captured only on said image plane. In FIG. 4B, a phase mask modifying the optical transfer function of the system is applied. The width of the ray fan is almost constant in the vicinity of the focus plane x=50. Therefore, the width of the ray fan is insensitive to the location of the image plane. As the width of the ray fan of FIG. 4B illustrates, a system with a phase mask does not as such produce a sharp image. Therefore, the image needs to be digitally processed in order to obtain a sharp image.

Returning to FIG. 2B, each image capturing apparatus 240 to 244 has a phase mask 250 to 254. Each phase mask 250 to 254 may have different characteristics. As each apparatus has a different a colour filter 226 to 230, the corresponding phase mask may be designed to optimally process the wavelengths the colour filter passes through.

The sensor 202 detects the filtered light rays and converts the light into an electric signal. The electric signal produced by the sensor 202 is digitised and taken to the signal processor 104. The signal processor processes the signals from the sensor in such a way that three separate subimages from the signals of the lenses 210 to 214 are produced, one filtered with a single colour. When producing the subimages the signal processor 104 removes the effect of the phase mask from each subimage. The signal processor may then combine the final image from the subimages.

Each subimage is sampled in full resolution in any given spectrum band, unlike in Bayer-matrix sampling. This improves the image quality of the final image compared to a non-lenslet camera. In Bayer-matrix sampling, the sampling for red and blue colours in a Bayer pattern is regular. However, the imaging spots are undersampled as only every other pixel is sampled both row-wise and column-wise. Furthermore, the sampling for green colour is irregular: every other column is sampled horizontally, but vertically every row is sampled, with one pixel shift sideways for two adjacent rows. The sampling is regular only diagonally, creating a complex sampling grid. In conclusion, sampling is regular for red and blue colours, but creates undersampled versions of red and blue spots. The sampling grid for green is regular, but very different from red and green colour sampling grids. This creates a need for a sampling rate conversion for different colours.

However, in the method described in the invention, the sampling for each colour is regular and perfect. This is advantageous, since the signal (the imaging spots) is perfectly sampled for each colour. There is no need for sampling rate or sampling grid conversions, as is the case in Bayer-matrix sampling.

An advantage of the invention is that interchannel crosstalk between colour channels is minimised. When a Bayer-matrix is utilised, there is always optical crosstalk from channel to channel. In crosstalk, a ray of light which should go to colour A pixel goes to colour B pixel because microlenses on top of a sensor cannot reflect light when the ray of light is coming to the colour A pixel at an angle which is too large compared to the normal of the surface of the sensor. This reduces the modulation transfer function of the sensor, and causes colour noise. The colour noise is very difficult to remove, because the angle spectrum for rays of light is generally unknown. The colour noise is increased when an inverse filter is applied to reconstruct the image, causing colour artefacts to the reconstructed image.

In a lenslet camera, however, the colour noise in totally removed, and a reconstructed image quality is better than when a Bayer matrix is utilised.

An advantage of the invention is that a better signal to noise ratio for blue channel is obtained. When a Bayer-matrix is utilised, the filter for the blue channel usually attenuates the light more than the filters for green and red colours. In most cases, the sensitivity of the sensor is also relatively low for blue. Therefore, the signal from blue pixels is lower than the signal from green or red pixels. To get a balanced image, the gain for the blue channel has to be increased, which also increases noise in the blue channel.

In the lenslet camera, however, the filters for different colours can be carefully tuned for each channel. In addition, each channel output may be balanced by using different apertures for each channel. Thus, the signal to noise ratio is improved for the blue channel, improving the reconstructed image quality over that of a Bayer-patterned sensor.

Yet another advantage of the invention is that wavelength tuning of lens systems for each colour channel improves image quality. When a Bayer-matrix is utilised, the lens system of the camera has to form an image over the full visible range, which requires a compromised lens. Thus, the resulted spots are colour-dependent, making it impossible to achieve good similarity of the spots in wave front coded systems.

In the lenslet camera, however, each channel can be carefully optimised for a narrow spectrum (colour) only, making the spots in each channel very similar to each other, which improves the quality of the reconstructed (inverse filtered) image.

FIG. 5 illustrates an example of the operation of a signal processor with a block diagram. The sensor detects a subimage and produces electric signal 500 to which sensor noise 502 is added. The subimage signal 504 is taken to the signal processor which may perform image processing 506. The signal processor filters the signal by removing the effect of the phase mask. Thus, a sharp image is obtained. Next, the image is filtered 508 to remove the sensor noise. The filtered subimage 510 is combined 512 with other similarly processed subimages 514. The combination produces the final colour image 516.

In an embodiment, the invention is realized in an imaging device module comprising at least three image capturing apparatuses, each apparatus including a lens system and a sensor and being configured to produce an image. Referring to FIG. 1, the module may comprise an image sensing arrangement 100, which is operationally connected to a processor 104. Each lens system comprises a phase mask which modifies the phase of incoming light rays such that the distribution of rays after the lens system is insensitive to the location of the sensor. The module may be installed in a device comprising a processor arranged to process an output signal of the module by removing the effect of the phase mask.

Even though the invention has been described above with reference to an example according to the accompanying drawings, it is clear that the invention is not restricted thereto but it can be modified in several ways within the scope of the appended claims.

1. An imaging device comprising at least three image capturing apparatuses, each apparatus including a lens system and a sensor and being configured to produce an image, the device further comprising a processor configured to combine at least a portion of the images with each other to produce a colour image, each lens system comprising a phase mask which modifies the phase of incoming light rays such that distribution of rays after the lens system is insensitive to the location of the sensor.

2. The device of claim 1, further comprising a processor arranged to process an output signal of the sensor by removing the effect of the phase mask.

3. The device of claim 1, wherein each phase mask of each lens system has different characteristics.

4. The device of claim 1, least three image capturing apparatuses each comprising a unique colour filter from a group of filters of red, green or blue.

5. The device of claim 1, wherein each of the three image capturing apparatuses comprises a unique colour filter from a group of filters of cyan, magenta or yellow.

6. The device of claim 1, wherein each lens system comprises a phase mask modifying the optical transfer function of each lens system such that the optical transfer function is insensitive to the location of the sensor.

7. A method of creating a colour image in an imaging device comprising at least three image capturing apparatuses, each apparatus including a lens system and a sensor and being arranged to produce an image, where the colour image is produced by combining at least a portion of the images with each other, the method comprising:
processing incoming rays of light in each lens system with a phase mask which modifies the phase of the incoming rays of light of such that the distribution of rays after the lens system is insensitive to the location of the sensor;
processing the image obtained by each apparatus in a processor by removing the effect of the phase mask from the image; and
combining the processed images produced with each apparatus with each other, thus obtaining a colour image.

8. The method of claim 7, further comprising: processing the incoming rays of light in each lens system with a phase mask with different characteristics.

9. The method of claim 7, further comprising: filtering the incoming rays of light in each lens system with a unique colour filter from a group of filters of red, green or blue.

10. The method of claim 7, further comprising: filtering incoming rays of light in each lens system with a phase mask modifying the optical transfer function (OTF) of each lens system such that the OTF is insensitive to the location of the sensor.

11. An imaging device module comprising at least three image capturing apparatuses, each apparatus including a lens system and a sensor and being configured to produce an image, each lens system comprising a phase mask which modifies the phase of incoming rays of light such that distribution of rays after the lens system is insensitive to the location of the sensor.

12. The module of claim 11, wherein the module is connected to a processor arranged to process the output signal of the module by removing the effect of the phase mask.
